(19) United States
(12) Patent Application Publication
(10) Pub. No.: US 2012/0013081 A1
(43) Pub. Date: Jan. 19, 2012

(54) CLAMPING AND RELEASING ASSEMBLY

(75) Inventors: Karen Anne Craig, Greensburg, PA (US); Kenneth George DeRoche, Greensburg, PA (US)

(73) Assignee: KENNAMETAL INC., Latrobe, PA (US)

(21) Appl. No.: 12/838,142

(22) Filed: Jul. 16, 2010

(51) Int. Cl. B23B 31/20

(52) U.S. Cl. 279/46.1

(57) ABSTRACT

A clamping and releasing mechanism includes a clamping and releasing assembly and a control member configured for effecting operation of the assembly. The assembly includes a collet, a biasing member, a rod member, and a retainer affixed to the rod member such that movement of the rod member relative to the collet causes a variation in the biasing force exerted by the biasing member. When the control member is moved in a first direction, the control member causes the rod member to move in a first direction relative to the collet and move the first part away from the second part. When the control member is moved in an opposite direction, the biasing member causes the rod member to move in an opposite direction and move the first part toward the second part. The mechanism is made of a few simple components, requires little maintenance and is self-contained.

### BACKGROUND OF THE INVENTION

Various types of quick clamping and releasing mechanisms exist in the art. Several of the mechanisms enable the tool to be easily retained and easily removed from the mechanism. While the clamping and releasing mechanisms appear to function satisfactorily for their intended purpose, designers strive to improve the art. Therefore, it is desirable to provide an improved clamping and releasing mechanism.

### SUMMARY OF THE INVENTION

The invention solves many problems associated with conventional clamping and releasing mechanisms. The mechanism of the invention is self-contained, i.e., does not have loose parts within the mechanism, such as fasteners, and the like. The mechanism of the invention allows for rapid replacement of a replacement part by a human or robot. In addition, the mechanism of the invention allows for easy loading of a replaceable part and a “bump off” feature for easy removal of the replacement part. Finally, the mechanism of the invention firmly holds the replaceable part in place with a minimum of movement by using a low spring pressure coupled with the wedging action of parts to create a tight connection.

In one aspect of the invention, a clamping and releasing mechanism comprises a clamping and releasing assembly comprising a collet; a rod member at least partially disposed within a passageway of the collet and configured for relative movement therewith; a retainer affixed to the rod member; a biasing member disposed between the retainer and the collet and exerting a biasing force against the retainer and the collet, wherein movement of the rod member relative to the collet causes a variation in the biasing force exerted by the biasing member; and a control member configured for exerting a biasing force against the rod member. When the biasing force exerted by the control member is greater than the biasing force exerted by the biasing member, the rod member moves in a first direction relative to the collet to cause the rod member to engage the second part, thereby causing a first part to move away from a second part. When the biasing force exerted by the control member is less than the biasing force exerted by the biasing member, the rod member moves in a second, opposite direction relative to the collet to cause the collet to engage the second part, thereby causing the first part to move toward the second part.

In another aspect, a clamping and releasing mechanism comprises a clamping and releasing assembly comprising a collet having one end with threads, a nose portion at an opposite end, and a body portion therebetween; a rod member at least partially disposed within a passageway of the collet and configured for relative movement therewith; a retainer affixed to the rod member; and a biasing member disposed between the retainer and the collet and exerting a biasing force against the retainer and the collet, wherein movement of the rod member relative to the collet causes a variation in the biasing force exerted by the biasing member; and a control member configured for exerting a biasing force against the rod member in such a way that when the biasing force exerted by the control member is greater than the biasing force exerted by the biasing member, the rod member moves in a first direction relative to the collet and engages the second part, thereby pushing a first part away from a second part, and when the biasing force exerted by the control member is less than the biasing force exerted by the biasing member, the rod member moves in a second, opposite direction relative to the collet and the collet engages the second part, thereby pulling the first part toward the second part.

In another aspect, a method of clamping and releasing a first part and a second part, the method comprising:
at least partially disposing a rod member within a passageway of a collet;
disposing a biasing member between a retainer and the collet, the retainer being affixed to the rod member in such a way that movement of the rod member relative to the collet causes a variation in a biasing force exerted by the biasing member; and
inserting a control member within an access hole of the second part, the control member having at least one tapered outer surface for exerting a biasing force against the rod member in such a way that when the biasing force exerted by the control member is greater than the biasing force exerted by the biasing member, the rod member moves in a first direction relative to the collet and engages the second part, thereby pushing a first part away from a second part, and when the biasing force exerted by the control member is less than the biasing force exerted by the biasing member, the rod member moves in a second, opposite direction relative to the collet and the collet engages the second part, thereby pulling the first part toward the second part

### BRIEF DESCRIPTION OF THE DRAWINGS

While various embodiments of the invention are illustrated, the particular embodiments shown should not be construed to limit the claims. It is anticipated that various changes and modifications may be made without departing from the scope of this invention.

FIG. 1 is a cross-sectional view of an exemplary embodiment of a clamping and releasing mechanism of the invention when in an unlocked position;

FIG. 2 is a cross-sectional view of an exemplary embodiment of the clamping and releasing mechanism of FIG. 1 when in a locked position;

FIG. 3 is a perspective view of an exemplary embodiment of a clamping and releasing assembly of the invention;

FIG. 4 is an exploded view of the clamping and releasing assembly of FIG. 3;

FIG. 5 is a perspective view of a collet with reverse threads used in the clamping and releasing assembly of FIG. 3;

FIG. 6 is an enlarged isometric view of the collet of FIG. 5;

FIG. 7 is a cross-sectional view of an alternate embodiment of a control member of the mechanism of FIG. 1 when the mechanism is in the unlocked position;

FIG. 8 is a cross-sectional view of another alternate embodiment of a control member of the mechanism of FIG. 1 when the mechanism is in the unlocked position;

FIG. 9 is a cross-sectional view of yet another alternate embodiment of a control member of the mechanism of FIG. 1 when in the mechanism is in the unlocked position; and

FIG. 10 is a cross-sectional view of the control member of FIG. 9 when the mechanism is in the locked position.

### DETAILED DESCRIPTION OF THE INVENTION

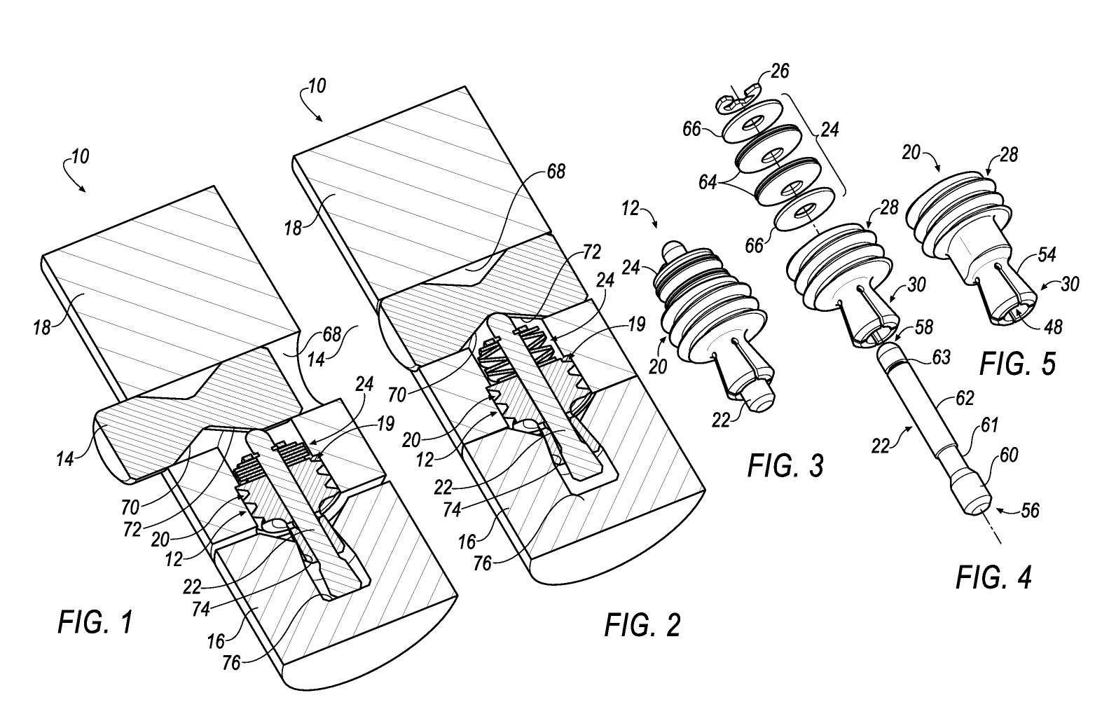

Referring now to FIGS. 1 and 2, a quick clamping and releasing mechanism 10 is shown according to an embodiment of the invention. In general, the mechanism 10 includes clamping and releasing assembly 12 and a control member 14 for effecting operation of the clamping and releasing assembly 12. FIG. 1 shows the mechanism 10 in an unlocked position and FIG. 2 shows the mechanism 10 in a locked position.

In general, the placing of the mechanism 10 from the unlocked position into the locked position (and vice versa) is achieved by means of a biasing force and using a low angle taper to activate a higher angle taper. In this manner, the mechanism 10 of the invention provides a self-contained clamping and releasing mechanism with simple parts that are relatively few in number, as compared to conventional clamping and releasing mechanisms. The mechanism 10 may be used, for example, for providing a clamping and releasing of a first part 16 to/from a second part 18. Although the invention is not limited by the type of first and second parts, the first part 16 can be, for example, a disposable or replaceable part, such as a cutting insert, wear tip, tool extension, and the like, and the second part can be, for example, a tool body, a shank, and the like.

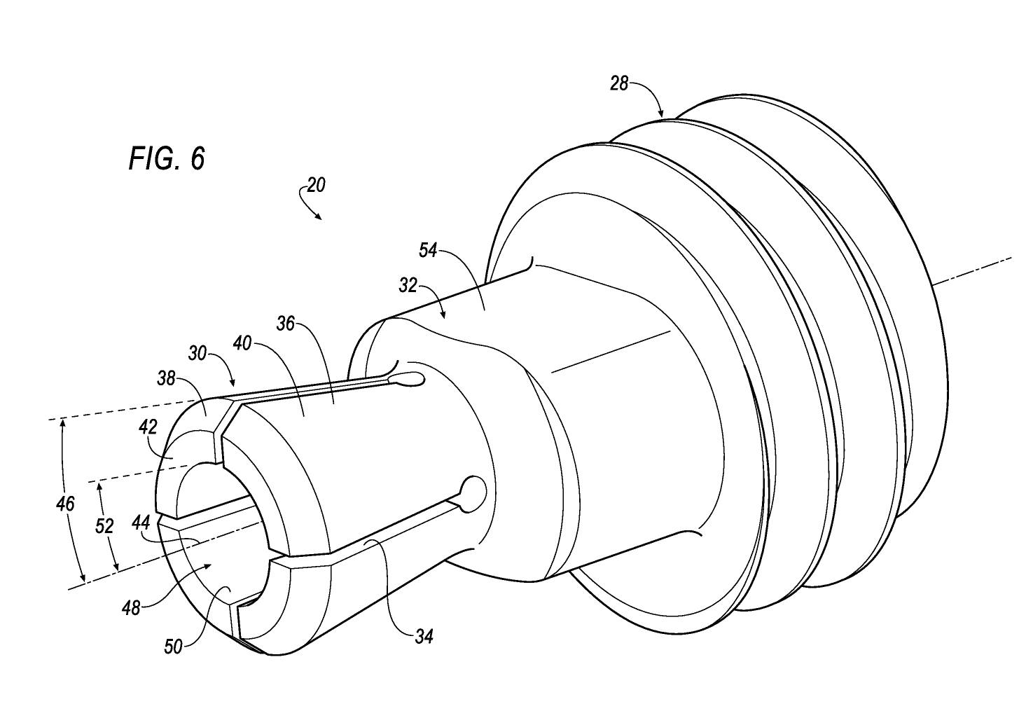

Referring now to FIGS. 3-5, the clamping and releasing assembly 12 includes a collet, shown generally at 20, a shaft or rod member 22 that is inserted through the collet 20 for relative movement therewith, a biasing member 24 and a retainer 26 for holding the biasing member 24 in place.

As shown in FIG. 6, the collet 20 is made from a resilient steel alloy and generally includes threads 28 at one end, a nose portion 30 at the opposite end, and a body portion 32 between the reverse threads 28 and the nose portion 30. The threads 28 allow the clamping and releasing assembly 12 to be screwed into the end of the second part 18 with a tool (not shown), such as a spanner type of wrench, and the like. In the illustrated embodiment, the threads 28 are reverse threads, however the invention can be practiced with any known means to attach the collet 20 to the second part 18. The nose portion 30 includes a generally parallel array of slots 34 separated by webs or gripping fingers 36. The slots 34 allow the gripping fingers 36 of the collet 20 to be radially expanded by the rod member 22 to grip the first part 16, and radially collapsed when no longer engaged by the rod member 22 to allow the first part 16 to be removed from the second part 18.

The nose portion 30 of the collet 20 includes an angled surface 38 that extends from an exterior surface 40 and a front surface 42. Specifically, the angled surface 38 tapers inwardly from the outer surface 40 to the front surface 42 of the collet 20. The exterior surface 40 has a taper angle 46 of greater than or equal to about twenty degrees (≧10°) with respect to a central, longitudinal axis 44 of the collet 20. The purpose of the relatively high taper angle 46 is to help seat the first part 16 by pulling the part 16 back towards the second part 18.

The collet 12 also includes a cylindrically-shaped passageway 48 that is concentrically provided along the central, longitudinal axis 44 of the collet 12. The dimensions of the passageway 48 through the nose portion 30 is such that the rod member 22 and be at least partially received within the passageway 48. Specifically, an interior surface 50 of the passageway 48 through the nose portion 30 of the collet 20 has a taper angle 52 that is less than the taper angle 46 of the exterior surface 40. For example, the taper angle 52 of the interior surface 50 may be less than or equal to about ten degrees (≦10°) with respect to the central, longitudinal axis 44 of the collet 20. The purpose of the relatively lower taper angle 52 is to greatly increase the clamping pressure of the exterior surface 40 with the higher taper angle 46 with a low amount of pressure. The relatively lower taper angle 52 also prevents the collet 20 from being compressed in use, thereby causing an accidental release of the first part 16 from the second part 18.

It will be appreciated that the magnitude of the taper angle 46 of the exterior surface 40 and the taper angle 52 of the interior surface 50 are examples, and that the invention can be practiced with any desirable taper angles, so long as the taper angle 46 of the exterior surface 40 is greater than the taper angle 52 of the interior surface 50.

The body portion 32 of the collet 20 is oblong-shaped in cross-section to serve as a drive/locating boss 54 to properly position the collet 20 within the second part 18. It will be appreciated that the boss 54 is optional, depending on the application. Also, the boss 54 can be any desirable shape.

Referring back to FIGS. 3-5, the rod member 22 is generally cylindrical in cross-sectional shape having a first end 56 and a second, opposite end 58. The second end 58 can have a radius to facilitate the engagement with the control member 14. The rod member 22 includes a tapered head portion 60 proximate the first end 56, a neck portion 61 and a body portion 62. The neck portion 61 has a smaller outer diameter than the head portion 60 and the body portion 62 for allowing the gripping fingers 36 of the collet 20 to collapse radially inward into the neck portion 61 when the mechanism 10 is placed into the released position, thereby facilitating removal of the second part 18. The body portion 62 has an outer diameter than may or may not be uniform, and is dimensioned such that the biasing member 24 is properly positioned about the rod member 22 for proper operation.

The tapered head portion 60 has approximately the same taper angle (about ≦10°) as the taper angle 52 of the interior surface 50 of the nose portion 30 of the collet 20. However, the dimension of the tapered head portion 60 as such that the outer diameter of the tapered head portion 60 is slightly larger than the outer diameter of the passageway 48 of the collet 20 such that the rod member 22 is only partially disposed within the collet 20. The slightly larger outer diameter allows the tapered head portion 60 of the rod member 22 to become wedged into the nose portion 30 of the collet 20 when the rod member 22 is moved relative to the collet 20 in a first direction along the longitudinal axis 44 to place the mechanism 10 in the locked position, as shown in FIG. 2. The rod member 22 includes an annular recess or groove 63 at a predetermined distance from the second end 58 of the rod member 22. The purpose of the groove 63 is to accommodate the retainer 26 such that the retainer 26 is affixed to the rod member 22. It is noted that the biasing member 24 exerts a biasing force against the retainer 26 and the collet 12. However, the retainer 26 is affixed to the rod member 26, and therefore holds the assembly 12 together. It is also noted that movement of the rod member 22 to move relative to the collet 12 causes a variation of the biasing force exerted by the biasing member 24.

In the illustrated embodiment, the biasing member 24 comprises one or more spring washers 64 of a type well-known in the art, such as Belleville washers, wave washers, and the like. In addition, the biasing member 24 comprises one or more flat washers 66. In the illustrated embodiment, the spring washers 64 are disposed between flat washers 66 such that one of the flat washers 66 abuts the reverse threads 28 of the collet 20 to provide a solid base for the spring washers 64. However, the relative position of the washers 64, 66 can be arranged in any desirable arrangement.

Referring back to FIGS. 1 and 2, the second part 18 includes an access hole 68 for accommodating the control member 14. In the illustrated embodiment, the access hole 68 is formed substantially perpendicular (about 90°) through the second part 18. However, it will be appreciated that the access hole 68 can be formed at any appropriate angle with respect to second part 18. The access hole 68 can be formed by drilling or any other well-known means in the art. In the illustrated embodiment, the control member 14 is generally cylindrical in shape having an outer surface with a pair of tapered surfaces 70, 72. The purpose of the tapered surfaces 70, 72 is to effect the locking and unlocking of the mechanism 10, as described below. It should be noted that only one tapered surface is necessary for operation of the mechanism 10 in the case where the control member 14 effect operation of the mechanism 10 from only one side of the second part 18. Two tapered surfaces 70, 72 allow for the control member 14 to effect operation of the mechanism 10 from opposite sides of the second part 18.

To assemble the mechanism 10, one end 58 of the rod member 22 is passed through the nose portion 30 of the collet 20. The biasing member 24 is assembled on end of the rod member 22. The retainer 26, such as an E-clip, and the like, is positioned within the groove 63 of the rod member 22 to hold the assembly 12 together. When the assembly 10 is first assembled, the spring washers 64 of the biasing member 24 are not compressed and the tapered head portion 60 of the rod member 22 is wedged within the interior surface 50 of the nose portion 30 of the collet 20, as shown in FIG. 2. Next, the assembly 12 is screwed into an threaded opening in the end of the second part 18, such as a tool holder, holding mechanism, and the like with an appropriate tool (not shown), such as a spanner type of wrench, and the like. The assembly 12 is screwed into the opening in the end of the second part 18 until the collet 20 abuts a ledge 19 in the opening of the second part 18. The purpose of the ledge 19 is to properly position the assembly 12 with respect to the control member 14 for proper operation of the mechanism 10.

In operation, the mechanism 10 is placed in the locked position by using the two tapered surfaces 70, 72 of the control member 14 to cause the gripping fingers 36 of the collet 20 to expand radially outward and exert pressure against the first part 16. As shown in FIG. 2, the biasing member 24 exerts a biasing force greater than the pressure exerted by the control member 14 against the rod member 22 to move the rod member 22 in a first direction along the central, longitudinal axis 44 of the collet 20 until the tapered head portion 60 of the rod member 22 is wedged in the interior surface 50 of the nose portion 30 of the collet 20. As the rod member 22 is wedged in the collet 20 by the biasing member 24, the nose portion 30 of the collet 20 expands radially outward to engage and grip a cavity 74 of the first part 16. The cavity 74 of the first part 16 has a reverse taper to mate with the exterior surface 40 of the collet 20. This gripping action causes the first part 16 to be pulled toward and abut and securely hold the second part 18 against the first part 16 to prevent separation of the parts 16, 18. At this point, the mechanism 10 is in the locked position.

To unlock the mechanism 10, one of the tapered surfaces 70, 72 of the control member 14 is used to apply pressure to the rod member 22 to overcome the biasing force exerted by the biasing member 24 against the collet 20 and to cause the rod member 22 to move in a second direction, opposite the first direction, along the central, longitudinal axis 44 of the collet 20. As the rod member 22 travels along the axis 44, the tapered head portion 60 of the rod member 22 is no longer wedged in the interior surface 50 of the nose portion 30 of the collet 20. As a result, the gripping fingers 36 contract radially inward. In addition, the end 56 of the rod member 22 engages an end surface 76 of the cavity 74 to “bump off” the first part 16 from the second part 18. The first part 16 can now be released from the second part 14 by applying pressure against the inside end face of the reverse taper. At this point, the mechanism 10 is in the unlocked position. To replace the first part 16, the rod member 22 is advanced and the new first part is pressed onto the collet 20 toward the second part 18.

It will be appreciated that the control member 14 illustrated in FIGS. 1 and 2 is only one example of the different types of possible mechanisms to apply pressure to the rod member 22 to effect locking and unlocking of the mechanism 10. The pressure can be applied with rod-type exterior tools or internal mechanisms. These mechanisms may be tapered rods, cam-like rotating pins, rod-type of push button, and the like. The orientation of these mechanisms depends on the type of mechanism.

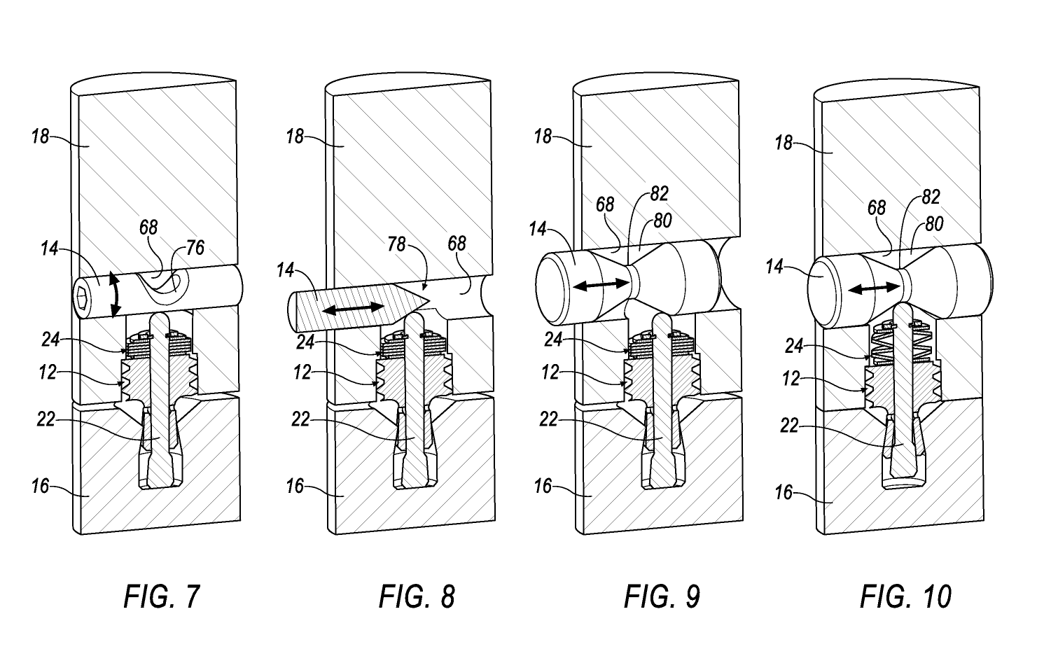

Referring now to FIGS. 7-10, some other possible examples of control members are shown. FIG. 7 shows a control member 14 in the form of a rotatable rod inserted into the hole 68 of the second part 18 to lock and unlock the mechanism 10. The control member 14 includes a grooved portion 76 that is substantially semi-hemispherical in shape. As shown in FIG. 7, the control member 14 is applying pressure against the rod member 22 to overcome the biasing force of the biasing member 24 and compressing the biasing member 24 in such a way that the mechanism 10 is in the unlocked position. To place the mechanism 10 in a locked position, the control member 14 is rotated in the direction of the arrows (i.e., clockwise or counter-clockwise) until the rod member 22 and the groove portion 76 are substantially aligned with one another. As a result, the biasing member 24 causes the rod member 22 to travel upward (as viewed in FIG. 7) into the grooved portion 76 of the control member 14. As the rod member 22 travels upward, the tapered head portion 60 of the rod member 22 engages the tapered interior surface of the collet 20 and pulls the first part 16 upward into abutment with the second part 18, thereby placing the mechanism 10 in the locked position.

FIG. 8 shows a control member 14 in the form of a simple rod with a V-shaped contoured end 78 inserted into the access hole 68 of the second part 18. As shown in FIG. 8, the control member 14 is applying pressure against the rod member 22 to overcome the biasing force of the biasing member 24 and compressing the biasing member 24 in such a way that the mechanism 10 is in the unlocked position. To place the mechanism 10 in a locked position, the control member 14 is moved in the direction of the arrow (i.e. to the left) until the biasing member 24 causes the rod member 22 to travel upward (as viewed in FIG. 8). As the rod member 22 travels upward, the tapered head portion 60 of the rod member 22 engages the tapered interior surface of the collet 20 and pulls the first part 16 upward into abutment with the second part 18, thereby placing the mechanism 10 in the locked position.

FIGS. 9 and 10 show a control member 14 in the form of a push button type of rod inserted into the hole 68 of the second part 18 to lock and unlock the mechanism 10, similar to the control member 14 shown in FIGS. 1 and 2. The control member 14 includes a V-shaped groove 80 with a radius 82 located at the center (i.e. lowest point) of the groove 80. As shown in FIG. 9, the control member 14 is applying pressure against the rod member 22 to overcome the biasing force of the biasing member 24 and compressing the biasing member 24 in such a way that the mechanism 10 is in the unlocked position. To place the mechanism 10 in a locked position, the control member 14 is moved in the direction of the arrow (i.e. to the right) until the biasing member 24 causes the rod member 22 to travel upward (as viewed in FIGS. 9 and 10). As the rod member 22 travels upward, the tapered head portion 60 of the rod member 22 engages the tapered interior surface of the collet 20 and pulls the first part 16 upward into abutment with the second part 18, thereby placing the mechanism 10 in the locked position, as shown in FIG. 10. It is noted that the radius 82 assists in keeping the rod member 22 centered while the mechanism 10 is in the locked position.

It will be appreciated that the invention is not limited by the various examples of the control member 14 of the mechanism 10, and that many other possible alternative embodiments of the invention are possible that use the concept of applying pressure against the rod member 22 to place the mechanism 10 in the unlocked position, and releasing the pressure to place the mechanism 10 in the locked position.

As described above, the mechanism 10 has many advantages over conventional mechanisms. First, the mechanism 10 is easy to use and is low maintenance. In addition, the mechanism 10 allows for the first part 16 to be quickly released from the second part 18 by means of a “bump off” feature (i.e., the rod member 22 pushing the first part 16 during release). The mechanism 10 is made of components that are relatively simple and few in number, many of which are commercially available at low cost. Further, the mechanism 10 has a compact design (the illustrated embodiment is only 8 mm in length).

The patents and publications referred to herein are hereby incorporated by reference.

Having described presently preferred embodiments the invention may be otherwise embodied within the scope of the appended claims.

What is claimed is:

1. A clamping and releasing mechanism, comprising:
a clamping and releasing assembly comprising a collet; a rod member at least partially disposed within a passageway of the collet and configured for relative movement therewith; a retainer affixed to the rod member; and a biasing member disposed between the retainer and the collet and exerting a biasing force against the retainer and the collet, wherein movement of the rod member relative to the collet causes a variation in the biasing force exerted by the biasing member; and
a control member configured for exerting a biasing force against the rod member,
wherein the rod member moves in a first direction relative to the collet when the biasing force exerted by the control member is greater than the biasing force exerted by the biasing member to cause the rod member to engage the second part, thereby causing a first part to move away from a second part; and
wherein the rod member moves in a second, opposite direction relative to the collet when the biasing force exerted by the control member is less than the biasing force exerted by the biasing member to cause the collet to engage the second part, thereby causing the first part to move toward the second part.

2. The mechanism of claim 1, wherein the collet includes threads at one end, a nose portion at an opposite end, and a body portion therebetween.

3. The mechanism of claim 2, wherein the nose portion includes an exterior surface with a first taper angle, and the passageway forming an interior surface with a second taper angle, the first taper angle being larger in magnitude than the second taper angle.

4. The mechanism of claim 2, wherein the body portion of the collet is oblong-shaped in cross-section to serve as a drive/locating boss to properly position the collet within the second part.

5. The mechanism of claim 1, wherein the rod member is generally cylindrical in cross-sectional shape having a first end and a second, opposite end, a tapered outer surface proximate the first end for engaging an interior surface of a nose portion of the collet, and an annular recess at a predetermined distance from the second end for affixing the retainer to the rod member.

6. The mechanism of claim 1, wherein the biasing member comprises one or more spring washers, flat washers, or a combination thereof.

7. The mechanism of claim 1, wherein the second part includes an access hole for accommodating the control member.

8. The mechanism of claim 1, wherein the control member includes at least one tapered outer surface for exerting the biasing force against the rod member.

9. A clamping and releasing mechanism, comprising:
a clamping and releasing assembly comprising a collet having one end with threads, a nose portion at an opposite end, and a body portion therebetween; a rod member at least partially disposed within a passageway of the collet and configured for relative movement therewith; a retainer affixed to the rod member; and a biasing member disposed between the retainer and the collet and exerting a biasing force against the retainer and the collet, wherein movement of the rod member relative to the collet causes a variation in the biasing force exerted by the biasing member; and
a control member configured for exerting a biasing force against the rod member in such a way that when the biasing force exerted by the control member is greater than the biasing force exerted by the biasing member, the rod member moves in a first direction relative to the collet and engages the second part, thereby pushing a first part away from a second part, and when the biasing force exerted by the control member is less than the biasing force exerted by the biasing member, the rod member moves in a second, opposite direction relative to the collet and the collet engages the second part, thereby pulling the first part toward the second part.

10. A method of clamping and releasing a first part and a second part, the method comprising:
at least partially disposing a rod member within a passageway of a collet;
disposing a biasing member between a retainer and the collet, the retainer being affixed to the rod member in such a way that movement of the rod member relative to the collet causes a variation in a biasing force exerted by the biasing member; and
inserting a control member within an access hole of the second part, the control member having at least one tapered outer surface for exerting a biasing force against the rod member in such a way that when the biasing force exerted by the control member is greater than the biasing force exerted by the biasing member, the rod member moves in a first direction relative to the collet and engages the second part, thereby pushing the first part away from the second part, and when the biasing force exerted by the control member is less than the biasing force exerted by the biasing member, the rod member moves in a second, opposite direction relative to the collet and the collet engages the second part, thereby pulling the first part toward the second part.
